(19) United States
(12) Patent Application Publication
(10) Pub. No.: US 2013/0180324 A1
(43) Pub. Date: Jul. 18, 2013

(54) TIRE STATE DETECTION DEVICE AND TIRE STATE DETECTION METHOD

(71) Applicants: Toshihiro Sota, Osaka (JP); Youichi Kurosawa, Osaka (JP); Hiroshi Fujimoto, Chiba (JP)

(72) Inventors: Toshihiro Sota, Osaka (JP); Youichi Kurosawa, Osaka (JP); Hiroshi Fujimoto, Chiba (JP)

(73) Assignee: PANASONIC CORPORATION, Osaka (JP)

(21) Appl. No.: 13/823,930

(22) PCT Filed: Sep. 22, 2011
(86) PCT No.: PCT/JP2011/005340

§ 371 Date: Mar. 26, 2013

(30) Foreign Application Priority Data
Oct. 12, 2010 (JP) 2010-229917

(51) Int. Cl. G01M 17/02

(52) U.S. Cl. CPC G01M 17/02
USPC 73/146

(57) ABSTRACT

A tire state detection device capable of detecting a tire state with high accuracy. This tire state detection device (100) is a device for detecting the tire state of a pneumatic tire (200) affixed to a wheel and comprises a vibration input unit (110) for inputting predetermined vibration to the tire (200), a frequency information acquisition unit (120) for acquiring frequency information relating to the tire (200) when the predetermined vibration is inputted, and a tire state estimation unit (130) for extracting the resonance frequency and anti-resonance frequency of the tire (200) from the acquired frequency information and calculating, from the extracted resonance frequency and anti-resonance frequency of the tire (200), an outer moment of inertia and a spring constant when the tire (200) is modeled using the outer moment of inertia, an inner moment of inertia, and the spring constant of elastic force acting therebetween.

### TECHNICAL FIELD

The present invention relates to a tire condition detection apparatus and tire condition detection method for detecting a tire condition.

### BACKGROUND ART

In recent years, demands for improvements in running stability and improvements in fuel consumption are being made with respect to vehicles such as automobiles and motorcycles, and research and development have been actively pursued in the field of elemental technologies that achieve such improvements.

Tire condition may be mentioned as one factor that significantly affects running stability and fuel consumption. In the case of a pneumatic tire, wear or a fall in the tire air pressure (hereinafter referred to as “tire internal pressure”) occurs as the result of running over a long time period or the like. Such kinds of changes in the tire condition cause a deterioration in fuel consumption and running stability. Accordingly, it is important to continuously detect and monitor the condition of tires.

However, when it is attempted to directly detect the tire condition by mounting a sensor that detects the tire internal pressure inside the tire or the like, although the tire condition can be detected with a high degree of precision, costs are incurred. In addition, communication processing occurs in order to notify the driver of the detection result obtained by the sensor. Therefore, in order to allow the sensor to operate while maintaining the sensor battery over a long time period, the intervals at which the sensor sends detection results to the driver must be made large. Therefore, it is difficult to ascertain the tire condition when needed.

Technology that indirectly detects a change in the tire internal pressure based on a resonance frequency of the tire is described, for example, in Non-Patent Literature (hereinafter, abbreviated as NPL) 1. The technology described in NPL 1 is based, firstly, on a relationship whereby the resonance frequency of a tire depends on the tire internal pressure, and the technology assumes a dynamic model of a tire and designs a disturbance observer based on the dynamic model. The dynamic model of the tire includes a moment of inertia of an outer portion of the tire (hereinafter referred to as “outer moment of inertia”), a moment of inertia of an inner portion of the tire (hereinafter referred to as “inner moment of inertia”), and a torsional spring connecting these. The technology described in NPL 1 calculates a torsional spring constant based on a resonance phenomenon generated in the tire accompanying running, and detects a change in the tire internal pressure based on a change in the torsional spring constant on the basis of the proportional relationship between the torsional spring constant of the tire and the tire internal pressure.

Further, technology that indirectly detects a tire condition based on a correlation between a tire driving force and a rotation angle of a tire is described, for example, in Patent Literature (hereinafter, abbreviated as PTL) 1. The technology described in PTL 1 detects, with respect to an electrically driven vehicle that is driven by an in-wheel motor, a correlation between a tire driving force and a rotation angle of the tire in a stopped state as a tire stiffness characteristic value. An in-wheel motor is a motor that applies a direct driving force to a tire, and has been the subject of research and development in recent years. The technology described in PTL 1 determines that the tire internal pressure has fallen if the tire stiffness characteristic value does not satisfy a criterion.

According to these conventional technologies, a tire condition can be indirectly detected.

### CITATION LIST

### Patent Literature

### PTL 1

Japanese Patent Application Laid-Open No. 2006-151282

### Non-Patent Literature

### NPL 1

Takaji Umeno, “Tire Pressure Estimation Using Wheel Speed Sensors”, Toyota Central R&D Labs., Inc. R&D Review, December 1997, Vol. 32 No. 4

### SUMMARY OF INVENTION

### Technical Problem

However, with the technology described in NPL 1, the accuracy of the disturbance observer decreases as an outer moment of inertia changes due to wear of the tire or the like, and thus the accuracy of a torsional spring constant that is calculated also decreases. Further, with the technology described in PTL 1, because the tire stiffness characteristic value is a value that is affected by changes in the thickness or elasticity of the tire, when wear of the tire proceeds, it is not possible to determine with a high degree of precision whether or not the tire internal pressure satisfies the criterion. That is, with the conventional technologies, there is the problem that a tire condition can not be detected with a high degree of precision.

It is an object of the present invention to provide a tire condition detection apparatus and tire condition detection method that enable a tire condition to be detected with a high degree of precision.

### Solution to Problem

A tire condition detection apparatus of the present invention detects a tire condition of a pneumatic tire fixed to a wheel, and has: a vibration input section that inputs predetermined vibration to the tire; a frequency information acquisition section that acquires frequency information of the tire when the predetermined vibration is input; and a tire condition estimation section that extracts a resonance frequency and an anti-resonance frequency of the tire from the acquired frequency information, and calculates an outer moment of inertia and a spring constant when the tire is modeled using the outer moment of inertia, an inner moment of inertia, and the spring constant of elastic force acting therebetween, from the extracted tire resonance frequency and anti-resonance frequency.

A tire condition detection method of the present invention detects a tire condition of a pneumatic tire fixed to a wheel, and has: a step of inputting predetermined vibration to the tire; a step of acquiring frequency information of the tire when the predetermined vibration is input; a step of extracting a resonance frequency and an anti-resonance frequency of the tire from the acquired frequency information; and a step of calculating an outer moment of inertia and a spring constant when the tire is modeled using the outer moment of inertia, an inner moment of inertia, and the spring constant of elastic force acting therebetween, from the extracted tire resonance frequency and anti-resonance frequency.

### Advantageous Effects of Invention

According to the present invention, since a resonance frequency and an anti-resonance frequency of a tire are extracted, a torsional spring constant of a dynamic model and an outer moment of inertia of a tire can be calculated on a case-by-case basis, and the tire condition can be detected with a high degree of precision.

### BRIEF DESCRIPTION OF DRAWINGS

FIG. 1 is a block diagram showing an example of the configuration of a tire condition detection apparatus according to Embodiment 1 of the present invention;

FIG. 2 is a drawing showing a dynamic model of a tire in Embodiment 1;

FIG. 3 is a flowchart showing an example of the operation of the tire condition detection apparatus according to Embodiment 1;

FIG. 4 is a drawing showing an example of the frequency characteristic of a tire in Embodiment 1;

FIG. 5 is a block diagram showing an example of the configuration of a tire condition detection apparatus according to Embodiment 2 of the present invention;

FIG. 6 is a flowchart showing an example of the operation of the tire condition detection apparatus according to Embodiment 2;

FIG. 7 is a block diagram showing an example of the configuration of a tire condition detection apparatus according to Embodiment 3 of the present invention;

FIG. 8 is a flowchart showing an example of the operation of the tire condition detection apparatus according to Embodiment 3;

FIG. 9 is a block diagram showing an example of the configuration of a tire condition detection apparatus according to Embodiment 4 of the present invention;

FIG. 10 is a flowchart showing an example of the operation of the tire condition detection apparatus according to

Embodiment 4;

FIG. 11 is a block diagram showing an example of the configuration of a tire condition detection apparatus according to Embodiment 5 of the present invention;

FIG. 12 is a control block diagram showing an example of the configuration of a motor drive system in Embodiment 5;

FIG. 13 is a block diagram showing an example of the configuration of a tire condition detection apparatus according to Embodiment 6 of the present invention;

FIG. 14 is a block diagram showing an example of the configuration of a tire condition detection apparatus according to Embodiment 7 of the present invention;

FIG. 15 is a block diagram showing an example of the configuration of a tire condition detection apparatus according to Embodiment 8 of the present invention; and

FIG. 16 is a block diagram showing an example of the configuration of a tire condition detection apparatus according to Embodiment 9 of the present invention.

### DESCRIPTION OF EMBODIMENTS

Now, embodiments of the present invention will be described in detail with reference to the accompanying drawings.

### Embodiment 1

First, the configuration of a tire condition detection apparatus according to Embodiment 1 will be described.

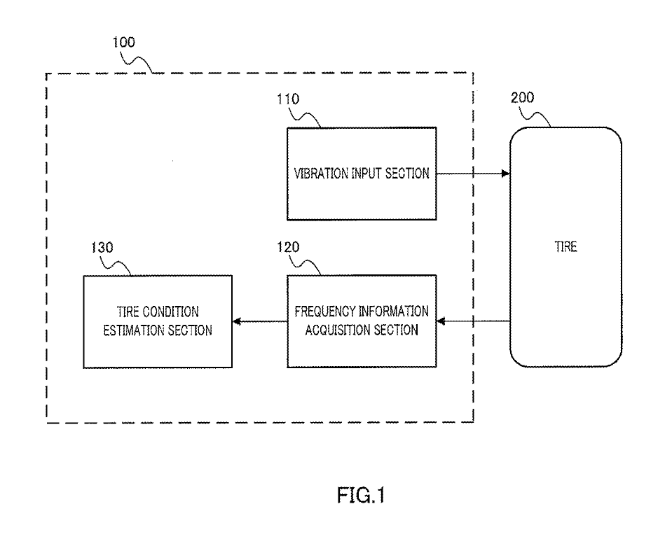

FIG. 1 is a block diagram showing an example of the configuration of a tire condition detection apparatus according to Embodiment 1.

As shown in FIG. 1, tire condition detection apparatus 100 is an apparatus connected to tire 200 fixed to a wheel (hereinafter referred to simply as “tire”). Tire condition detection apparatus 100 has vibration input section 110, frequency information acquisition section 120, and tire condition estimation section 130. Tire 200 is connected to this vehicle in a stable and fixed manner, and includes a gas such as air, nitrogen, or the like, between itself and the wheel.

Vibration input section 110 inputs predetermined vibration to tire 200. In order for the anti-resonance frequency of tire 200 to be easily extracted by frequency information acquisition section 120 described later herein, the predetermined vibration is minute back-and-forth vibration applied in the direction of rotation of tire 200, and is defined by torque magnitude and vibrational frequency. Hereinafter, this predetermined vibration is called “anti-resonance vibration”, and torque that is applied to a rim of tire 200 by anti-resonance vibration is called “anti-resonance torque”.

Vibration input section 110 may apply vibration by controlling the drive system of tire 200 electrically or mechanically, or may apply vibration mechanically directly to tire 200 separately from the drive system. If vibration is directly applied mechanically, vibration input section 110 can be, for example, an electromagnetic vibrator, or an unbalanced-mass vibrator in which an eccentric mass is attached to a small motor, that is attached to the wheel of tire 200 or the like. Vibration input section 110 can also be, for example, a damper oil-pressure control apparatus, such as active suspension.

Frequency information acquisition section 120 acquires tire 200 frequency information when anti-resonance vibration is input by vibration input section 110. Frequency information is information for extracting the tire 200 resonance frequency and anti-resonance frequency described later herein. Frequency information includes the rotational angular velocity of tire 200, for example. Also, when rim 220 of tire 200 is driven by a motor, frequency information is an inverter control voltage for the motor drive current flowing in a motor-drive vehicle. In the case of rotational angular velocity, for example, an encoder (not shown) can be installed and can acquire a rotation angle of the rim, and rotational angular velocity can be acquired by performing temporal differentiation on rim rotation angles. The encoder is constituted, for example, by a rotor that rotates in synchrony with tire 200, and a sensor that detects a rotation angle of the rotor and converts the rotation angle into an electrical signal. The encoder may be, for example, an optical encoder such as an incremental encoder or absolute encoder, or an electromagnetic encoder comprising a Hall element or the like.

Tire condition estimation section 130 extracts the resonance frequency and the anti-resonance frequency of tire 200 from frequency information acquired by frequency information acquisition section 120, and estimates the condition of tire 200. Then tire condition detection apparatus 100 estimates the condition of tire 200 using a dynamic model of tire 200. Specifically, tire condition estimation section 130 calculates a torsional spring constant and an outer moment of inertia of a dynamic model of tire 200 each time detection of the condition of tire 200 is performed. Then tire condition estimation section 130 estimates the condition of tire 200 based on the calculated torsional spring constant and outer moment of inertia.

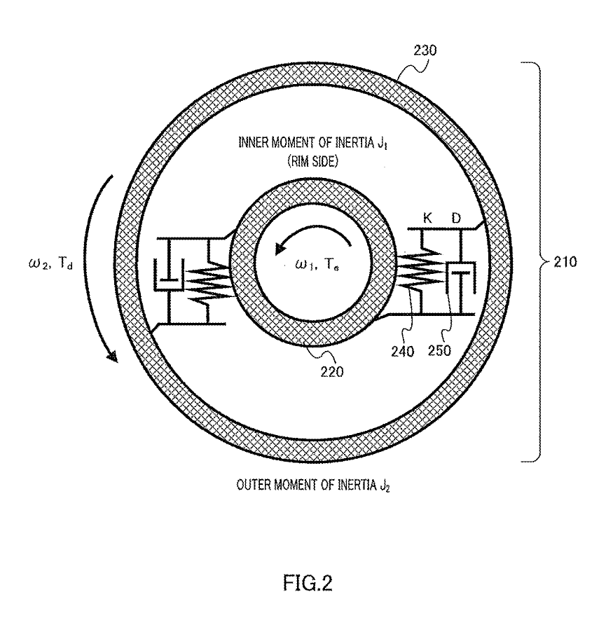

FIG. 2 is a drawing showing a dynamic model of tire 200 used by tire condition estimation section 130.

As shown in FIG. 2, tire 200 dynamic model 210 includes a moment of inertia of tire 200 rim 220, a moment of inertia of tire 200 tread 230, spring (torsional spring) 240 connecting these, and damper 250. That is to say, tire 200 dynamic model 210 models mechanical vibration generated in tire 200 as a torsional vibration phenomenon.

Dynamic model 210 is represented using the following variables.
J₁: Moment of inertia of rim 220 (inner moment of inertia)
J₂: Moment of inertia of tread 230 (outer moment of inertia)
K: Torsional spring constant of tire 200
D: Equivalent viscosity coefficient of tire 200
Tₑ: Output torque applied to rim 220 from vehicle side
T_{d}: Disturbance torque applied to tread 230 from road surface due to rolling of tire 200
ω₁: Rotational angular velocity of rim 220
ω₂: Rotational angular velocity of tread 230

Here, θₛ denotes the rotation angle difference between rim 220 and tread 230. Moment of inertia J₁ and equivalent viscosity coefficient D, are parameters that can be regarded as fixed values. Outer moment of inertia J₂ is a parameter that can change due to wear of tire 200 and the like. Torsional spring constant K is a parameter representing the elasticity of the side-surface rubber part of tire 200 that connects rim 220 and tread 230, and is dependent upon air pressure (tire internal pressure). Output torque Tₑ is a control object. Disturbance torque T_{d} is an unknown parameter. Rotational angular velocity ω₁ is a parameter that can be measured with a high degree of precision.

Although not shown in the drawings, tire condition detection apparatus 100 has, for example, a CPU (Central Processing Unit), a storage medium such as RAM (Random Access Memory), and so forth. In this case some or all of the above-described functional sections are implemented by having the CPU execute a control program. Tire condition detection apparatus 100, for example, takes the form of an ECU (Electric Control Unit) that is installed in a vehicle and is connected to the drive system of tire 200.

Since such tire condition detection apparatus 100 extracts the resonance frequency and the anti-resonance frequency of tire 200, it can detect the condition of tire 200 by acquiring the torsional spring constant and the outer moment of inertia of tire 200 with a high degree of precision. That is to say, even if the outer moment of inertia changes due to wear or replacement of tire 200 or the like, tire condition detection apparatus 100 can perform detection of the condition of tire 200 based on a value of the outer moment of inertia after the change. Therefore, tire condition detection apparatus 100 can detect the tire condition with a high degree of precision.

The operation of tire condition detection apparatus 100 will now be described.

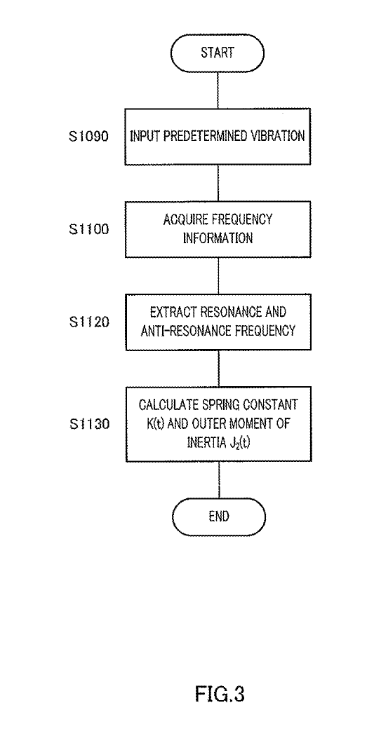

FIG. 3 is a flowchart showing an example of the operation of tire condition detection apparatus 100 according to Embodiment 1.

First, each time timing for estimating the tire condition (hereinafter referred to as “estimation execution timing”) arrives, vibration input section 110 inputs predetermined vibration to tire 200 (S1090). Estimation execution timing may be while a vehicle that is a detection object is running or is stopped, and may be while the vehicle is running at a constant speed or running at an inconstant speed. Also, estimation execution timing may arrive with predetermined periodicity, or may be when a predetermined operation such as depression of a switch is performed by the driver.

Then frequency information acquisition section 120 acquires tire 200 frequency information, and outputs the acquired frequency information to tire condition estimation section 130 (S1100). Tire condition estimation section 130 extracts the resonance frequency and anti-resonance frequency of tire 200 from the input frequency information (S1120). Then tire condition estimation section 130 calculates outer moment of inertia J₂ and torsional spring constant K of tire 200 based on the extracted resonance frequency and anti-resonance frequency.

Here, a method is described whereby tire condition estimation section 130 detects a resonance frequency and an anti-resonance frequency, and calculates outer moment of inertia J₂ and torsional spring constant K based on the resonance frequency and the anti-resonance frequency. Here, a case is described in which rim 220 rotational angular velocity ω₁ is input to tire condition estimation section 130 as frequency information.

Frequency information is, for example, a rotational angular velocity or a frequency of a control voltage for driving a motor.

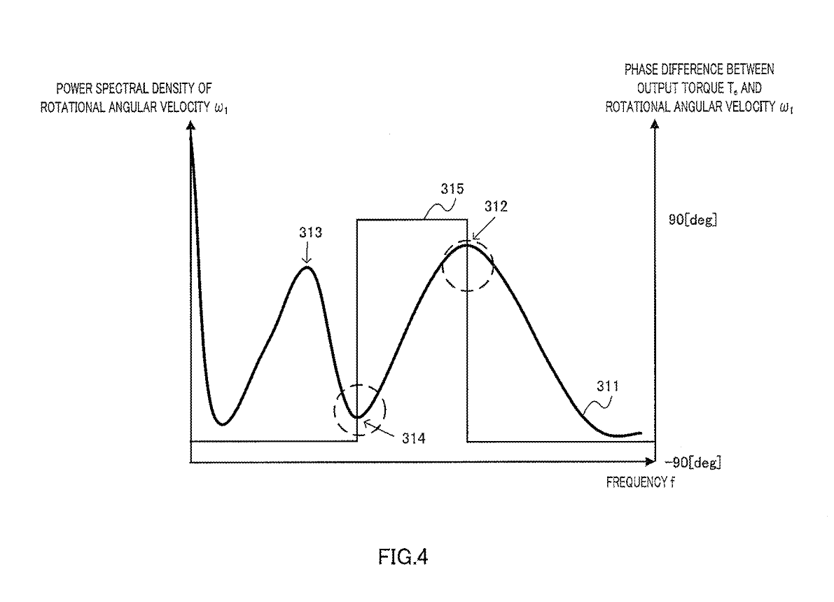

FIG. 4 is a drawing showing an example of the frequency characteristic of tire 200. The horizontal axis indicates frequency f, and the vertical axis indicates the power spectral density of rim 220 rotational angular velocity ω₁ and the phase difference between output torque Tₑ and rotational angular velocity ω₁.

Tire condition estimation section 130 can obtain spectral waveform 311 shown in FIG. 4 by performing frequency analysis such as an FFT (Fast Fourier Transform) on rim 220 rotational angular velocity ω₁. Spectral waveform 311 indicates a frequency characteristic of tire 200.

As shown in FIG. 4, in spectral waveform 311, a resonance frequency that is affected by tire internal pressure appears at frequency 312 as coupled resonance of suspension back-and-forth vibration and tire 200 torsional spring resonance. Details of this phenomenon are given in NPL, for example, and therefore a description thereof is omitted here.

In spectral waveform 311, on the one hand a peak of a sharp crest appears at above-mentioned frequency 312, which is the resonance frequency of tire 200, and on the other hand a peak of a sharp trough appears at anti-resonance frequency 314.

Therefore, tire condition estimation section 130 acquires resonance frequency 312 and anti-resonance frequency 314 by detecting the peak positions in spectral waveform 311. At these peak positions, there is a property that phase difference 315 is inverted by 180 degrees. Therefore, tire condition estimation section 130 can acquire resonance frequency 312 and anti-resonance frequency 314 by identifying a frequency at which phase difference 315 is inverted from 90 degrees to −90 degrees and a frequency at which phase difference 315 is inverted from −90 degrees to 90 degrees.

In FIG. 4, although, in addition to frequency 312, frequency 313 is another frequency at which there is a peak, it is empirically known that a frequency of a peak that appears from around 10 Hz to 15 Hz is a frequency that depends on the specifications of the tire. Consequently, resonance frequency 312 can also be detected by suppressing the level of frequency 313 by means of a filter.

Incidentally, an equation of state shown in equation 1 below is derived from the dynamic model shown in FIG. 2.

$$\begin{matrix} [ 1 ] & \\ [ \begin{matrix}{\dot{ω}}_{1} \\ {\dot{θ}}_{s} \\ {\dot{ω}}_{2}\end{matrix} ] = [ \begin{matrix}- \frac{D}{{J}_{1}} & - \frac{K}{{J}_{1}} & \frac{D}{{J}_{1}} \\ 1 & 0 & - 1 \\ \frac{D}{{J}_{2}} & \frac{K}{{J}_{2}} & - \frac{D}{{J}_{2}}\end{matrix} ] [ \begin{matrix}\begin{matrix}{ω}_{1} \\ {θ}_{s}\end{matrix} \\ {ω}_{2}\end{matrix} ] + [ \begin{matrix}\frac{1}{{J}_{1}} & 0 \\ 0 & 0 \\ 0 & \frac{1}{{J}_{2}}\end{matrix} ] [ \begin{matrix}{T}_{e} \\ {T}_{d}\end{matrix} ] & ( Equation 1 )\end{matrix}$$

Further, an input-output transfer function matrix shown in equation 2 below is obtained from equation 1.

$$\begin{matrix}[ 2 ] & \\ [ \begin{matrix}{ω}_{1} \\ {ω}_{2}\end{matrix} ] = [ \begin{matrix}{G}_{11} ( s ) & {G}_{12} ( s ) \\ {G}_{21} ( s ) & {G}_{22} ( s )\end{matrix} ] [ \begin{matrix}{T}_{e} \\ {T}_{d}\end{matrix} ] & ( Equation 2 )\end{matrix}$$

Equivalent viscosity coefficient D of tire 200 can be set to 0 since equivalent viscosity coefficient D does not affect the resonance frequency and anti-resonance frequency of the torsional spring. Therefore, transfer function G₁₁(s) from output torque Tₑ applied to rim 220 to rotational angular velocity ω₁ of rim 220 can be expressed with equation 3 below. Here, s denotes a Laplace operator, ω_{c0} denotes a resonance angular frequency, and ωₐ denotes an anti-resonance angular frequency.

$$\begin{matrix}[ 3 ] & \\ {G}_{11} ( s ) = \frac{1}{{J}_{1} \cdot s} \cdot \frac{{s}^{2} + \frac{K}{{J}_{2}}}{{s}^{2} + \frac{K}{{J}_{2}} + \frac{K}{{J}_{1}}} = \frac{1}{{J}_{1} \cdot s} \cdot \frac{{s}^{2} + {ω}_{a}^{2}}{{s}^{2} + {ω}_{c 0}^{2}} & ( Equation 3 )\end{matrix}$$

From equation 3, resonance frequency f_{c0} and anti-resonance frequency fₐ of tire 200 are derived as shown in equation 4 and equation 5 below.

$$\begin{matrix}[ 4 ] & \\ {f}_{c 0} = \frac{1}{2 π2} \sqrt{K ( \frac{1}{{J}_{1}} + \frac{1}{{J}_{2}} )} & ( Equation 4 ) \\ [ 5 ] & \\ {f}_{a} = \frac{1}{2 π} \sqrt{\frac{K}{{J}_{2}}} & ( Equation 5 )\end{matrix}$$

Therefore, tire condition estimation section 130 can calculate torsional spring constant K and outer moment of inertia J₂ by detecting resonance frequency f_{c0} and anti-resonance frequency fₐ and performing processing that solves the simultaneous equations of equation 4 and equation 5.

Here, frequency information includes a large amount of vibration noise due to vibration components other than a torsional resonance frequency, caused by a coefficient of friction between a tire and the road surface, and irregularities. Anti-resonance frequency fₐ is difficult to detect with conventional technology since it tends to be buried in this noise.

Thus, as explained above, tire condition detection apparatus 100 inputs to tire 200 predetermined vibration that facilitates the extraction of anti-resonance frequency fₐ by vibration input section 110. By this means, tire condition detection apparatus 100 can extract anti-resonance frequency fₐ more dependably and with a high degree of precision.

Tire condition estimation section 130 may also calculate resonance frequency f_{c0} and anti-resonance frequency fₐ, and calculate torsional spring constant K and outer moment of inertia J₂, by means of the method described below, for example.

Tire condition estimation section 130 may also calculate torsional spring constant K and outer moment of inertia J₂ by another method that utilizes a recursive least-squares estimation method. According to this method, tire condition estimation section 130 estimates unknown parameter vector θ=[θ₁ θ₂]^{T}=[ω_{c0}² ωₐ²]^{T}=[4π²f_{c0}² 4π²fₐ²]^{T}.

In this case, as shown below, equation 8 is derived through equation 7 from the relational expression of equation 6 using equation 3 of transfer function G₁₁(s) from output torque Tₑ to rotational angular velocity ω₁ of the rim that is described above. Then, observable vector ξ₁ and observable output y can be defined as shown in equation 9 and equation 10.

$$\begin{matrix}[ 6 ] & \\ {ω}_{1} = {G}_{11} ( s ) {T}_{e} = \frac{1}{{J}_{1} \cdot s} \cdot \frac{{s}^{2} + {ω}_{a}^{2}}{{s}^{2} + {ω}_{c 0}^{2}} {T}_{e} & ( Equation 6 ) \\ [ 7 ] & \\ {J}_{1} {\ddot{ω}}_{1} + {J}_{1} {ω}_{c 0}^{2} {\dot{ω}}_{1} = {\ddot{T}}_{e} + {ω}_{a}^{2} {T }_{e} & ( Equation 7 ) \\ [ 8 ] & \\ [ \begin{matrix}{θ}_{1} & {θ}_{2}\end{matrix} ] [ \begin{matrix}{J}_{1} {\dot{ω}}_{1} \\ - {T}_{e }\end{matrix} ] = {\ddot{T}}_{e} - {J}_{1} {{ω}^{...}}_{1} & ( Equation 8 ) \\ [ 9 ] & \\ ξ = {[ \begin{matrix}{J}_{1} {\dot{ω}}_{1} & - {T}_{e}\end{matrix} ]}^{T} & ( Equation 9 ) \\ [ 10 ] & \\ y = {\ddot{T}}_{e} - {J}_{1} {{ω}^{...}}_{1} & ( Equation 10 )\end{matrix}$$

Tire condition estimation section 130 decides unknown parameter θ using observable parameter ξ and output y so that an evaluation function of equation 11 becomes a minimum.

$$\begin{matrix}[ 11 ] & \\ J ( \hat{θ} ) = {\sum }_{i = 0}^{k} {{ρ}^{k - i} [ {\hat{θ}}^{T} \cdot ξ ( i ) - y ( i ) ]}^{2} ( 0 < ρ < 1 ) & ( Equation 11 )\end{matrix}$$

Then tire condition estimation section 130 can determine unknown parameter θ by means of equation 12 and equation 13 below that are obtained by expanding equation 11. By this means, resonance frequency f_{c0} and anti-resonance frequency fₐ can be calculated.

$$\begin{matrix} [ 12 ] & \\ Γ ( k ) = \frac{1}{ρ} \{ Γ ( k - 1 ) - \frac{Γ ( k - 1 ) ξ ( k ) {ξ}^{T} ( k ) Γ ( k - 1 )}{ρ + {ξ}^{T} ( k ) Γ ( k - 1 ) ξ ( k )} \} & ( Equation 12 ) \\ [ 13 ] & \\ \hat{θ} ( k ) = \hat{θ} ( k - 1 ) - \frac{Γ ( k - 1 ) ξ ( k )}{ρ + {ξ}^{T} ( k ) Γ ( k - 1 ) ξ ( k )} ( {ξ}^{T} ( k ) \hat{θ} ( k - 1 ) - y ( k ) ) & ( Equation 13 )\end{matrix}$$

Then tire condition estimation section 130 calculates torsional spring constant K and outer moment of inertia J₂ of tire 200 using equation 4 and equation 5 based on the calculated resonance frequency f_{c0} and anti-resonance frequency fₐ (S1130).

Thus, if tire condition detection apparatus 100 can extract only resonance frequency f_{c0} and anti-resonance frequency fₐ, it can calculate torsional spring constant K and outer moment of inertia J₂ representing the current condition of tire 200 with a high degree of precision.

As described above, tire condition detection apparatus 100 according to Embodiment 1 applies predetermined vibration to tire 200, acquires tire 200 frequency information, and extracts the resonance frequency and the anti-resonance frequency of tire 200 from that frequency information. Then tire condition detection apparatus 100 estimates the condition of tire 200 from the extracted resonance frequency and anti-resonance frequency. By this means, tire condition detection apparatus 100 can calculate a torsional spring constant and an outer moment of inertia of a tire 200 dynamic model on a case-by-case basis, and can detect the condition of tire 200 with a high degree of precision.

With the technology described in above NPL 1, since the anti-resonance frequency is not used for detection of the condition of tire 200, input of vibration for facilitating the extraction of the anti-resonance frequency of tire 200 described later herein is not performed. Therefore, with the technology described in NPL 1, an anti-resonance frequency cannot be extracted dependably and with a high degree of precision.

Further, with respect to the disturbance observer, the technology described in the aforementioned NPL 1 treats inner moment of inertia J₁ and outer moment of inertia J₂ as constants that are determined by the materials and shapes of the wheel and the tire rubber. Therefore, in a case where a value of outer moment of inertia J₂ has changed significantly due to wear or replacement of tire 200, irrespective of the fact that the tire internal pressure has not changed, the technology described in NPL 1 estimates that torsional spring constant K has changed.

Therefore, as compared with this kind of technology described in NPL 1, tire condition detection apparatus 100 according to the present invention can perform detection of the condition of tire 200 with a higher degree of precision.

Although in the above description the predetermined vibration is described as anti-resonance vibration in order to facilitate extraction of the anti-resonance frequency, the predetermined vibration is not limited thereto. The predetermined vibration may be a vibration that includes not only an anti-resonance vibration but also minute back-and-forth vibration (resonance vibration) applied in the direction of rotation of tire 200 so that frequency information acquisition section 120 can easily extract the resonance frequency of tire 200. In such case, torque applied to the rim of tire 200 may be taken as “resonance and anti-resonance torque.”

By this means, frequency information acquisition section 120 can easily extract the resonance frequency also, and can detect the tire condition with a higher degree of precision.

### Embodiment 2

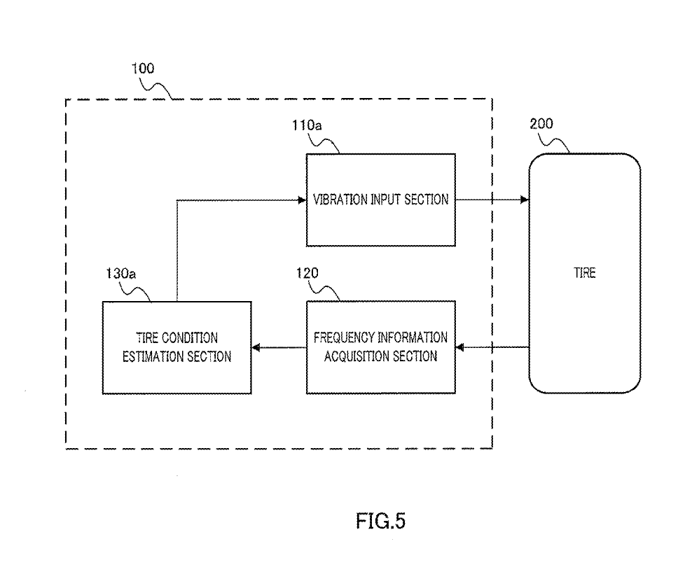

FIG. 5 is a block diagram showing an example of the configuration of a tire condition detection apparatus according to Embodiment 2 of the present invention, corresponding to FIG. 1 of Embodiment 1. Components that are identical to components in FIG. 1 are assigned the same reference symbols, and descriptions thereof are omitted in the following text.

Tire condition detection apparatus 100 according to Embodiment 2 mainly differs from Embodiment 1 in being provided with vibration input section 110a and tire condition estimation section 130a. Vibration input section 110a is a functional section that decides anti-resonance vibration based on information related to the tire condition acquired in the past. Tire condition estimation section 130a is a functional section that feeds back the tire condition related information.

Tire condition estimation section 130a determines whether or not tire 200 air pressure has dropped markedly based on a change in torsional spring constant K. Then tire condition estimation section 130a holds resonance frequency f_{c0}, anti-resonance frequency fₐ and a determination result as to whether or not there is a marked drop in tire air pressure (hereinafter referred to as “air pressure drop”) due to a puncture or the like.

Vibration input section 110a acquires resonance frequency f_{c0}, anti-resonance frequency fₐ and information on the presence or absence of an air pressure drop held by tire condition estimation section 130a. Then, based on these items of information, vibration input section 110a controls at least one or the other of torque magnitude and vibrational frequency, or both of these, so that anti-resonance frequency fₐ becomes easily extracted vibration. If one or the other of torque magnitude and vibrational frequency is a fixed value, vibration input section 110a needs only control the one that is not a fixed value.

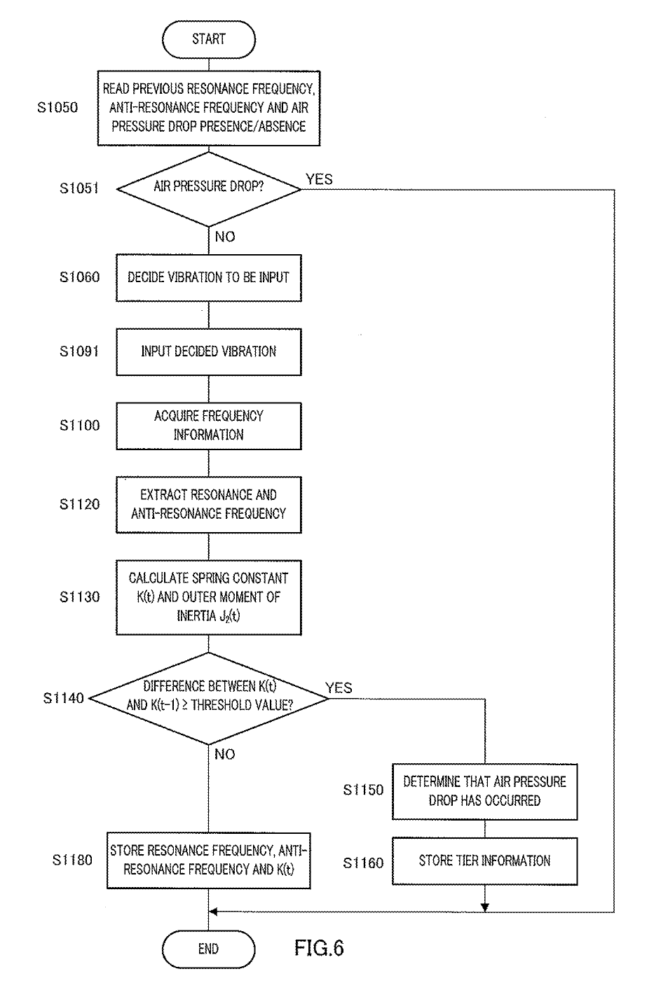

FIG. 6 is a flowchart showing an example of the operation of tire condition detection apparatus 100 according to Embodiment 2, corresponding to FIG. 3 of Embodiment 1. Steps that are identical to steps in FIG. 3 are assigned the same step numbers, and descriptions thereof are omitted in the following text.

Each time estimation execution timing arrives, vibration input section 110a reads the previous resonance frequency f_{c0}, anti-resonance frequency fₐ and information on the presence or absence of an air pressure drop held in tire condition estimation section 130a (S1050). Here, the term “(the) previous” refers to the frequencies and information or the like acquired at the previous estimation execution timing.

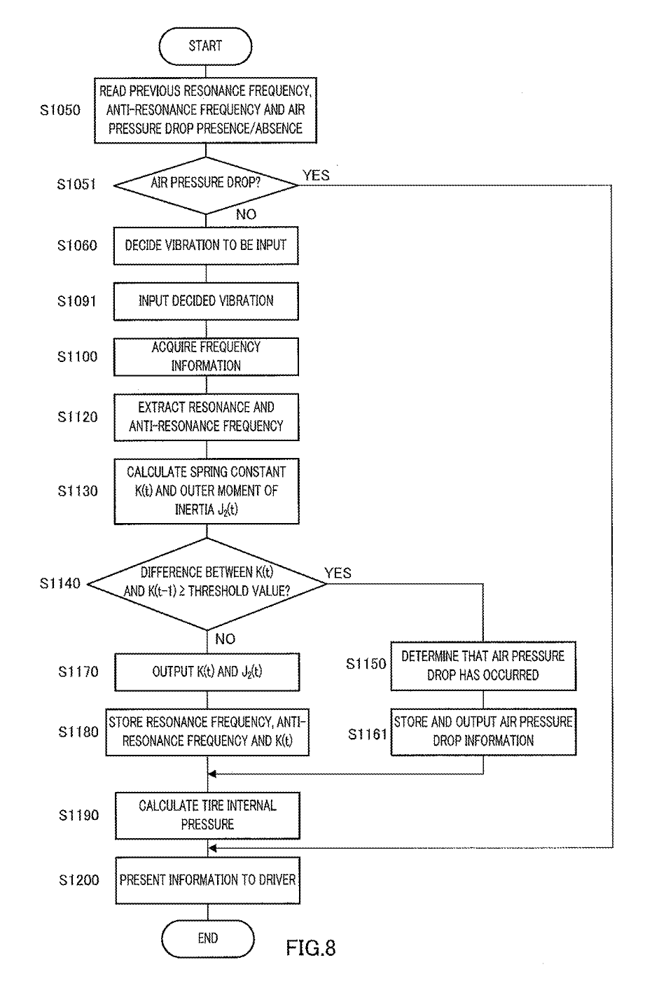

In this information read, for example, provision may be made for vibration input section 110a to send an information request command to tire condition estimation section 130a. That is to say, the information read may be performed by tire condition estimation section 130a, on acquiring this information request command, sending the information to vibration input section 110a. Then, if there is no air pressure drop (S1051: NO), vibration input section 110a decides anti-resonance vibration for causing vibration including this resonance frequency f_{c0} and anti-resonance frequency fₐ (S1060). Then vibration input section 110a inputs the decided anti-resonance vibration to tire 200 (S1091). Details of the anti-resonance vibration decision will be given later herein. If there is an air pressure drop (S1051: YES), vibration input section 110a proceeds to, for example, step S1200 described later herein (referred to FIG. 8) the processing without performing anti-resonance vibration output.

On the other hand, when tire condition estimation section 130a calculates torsional spring constant K(t) (S1130), tire condition estimation section 130a determines whether or not the difference between present torsional spring constant K(t) and previous torsional spring constant K(t−1) is greater than or equal to a predetermined threshold value (S1140). Here, the term “(the) present” refers to the value or the like acquired at the present estimation execution timing. In addition, t indicates that the parameter is based on the latest frequency information, and t-n indicates that the parameter is based on frequency information input at estimation execution timing n times before.

If the difference between present torsional spring constant K(t) and previous torsional spring constant K(t−1) is greater than or equal to the threshold value (S1140: YES), tire condition estimation section 130a determines that a tire 200 air pressure drop has occurred (S1150). That is, tire condition estimation section 130a determines whether or not the tire internal pressure can be said to have changed sharply. Then tire condition estimation section 130a stores air pressure drop information indicating that an air pressure drop has occurred (S1160).

This air pressure drop information is read by vibration input section 110a in step S1050 of the next estimation execution timing (hereinafter referred to simply as “(the) next . . . ”). Then vibration input section 110a stops anti-resonance vibration output until reset processing is performed after a tire change or repair—that is, until air pressure drop information indicating no air pressure drop is input. This reset processing is directed by depression of a reset button or the like (not shown) by the driver or the like after a tire change has been performed. When reset processing is directed, tire condition estimation section 130a discards stored tire air pressure drop information.

If the difference is less than the threshold value (S1140: NO), tire condition estimation section 130a stores resonance frequency f_{c0}, anti-resonance frequency fₐ and spring constant K(t) (S1180). Of these, resonance frequency f_{c0} and anti-resonance frequency fₐ are read by vibration input section 110a in next step S1050, while spring constant K(t) is used as previous spring constant K(t−1) in next step S1140.

Tire condition estimation section 130a may also store spring constants K(t−1), K(t−2), . . . K(t−m) (where m is a positive integer) of a plurality of times. Then tire condition estimation section 130a may use the difference between any one, or the largest, or the average, of the stored plurality of spring constants and present spring constant K(t) in a determination.

Details of the above anti-resonance frequency decision will now be given.

At a stage at which anti-resonance frequency fₐ is unknown, vibration that facilitates the extraction of anti-resonance frequency fₐ is also unknown. Therefore, vibration input section 110a decides anti-resonance torque to be sinusoidal torque sweeping from a low frequency to a high frequency, or from a high frequency to a low frequency, in a wide frequency band. That is to say, in an initial state in which anti-resonance frequency is unknown, vibration input section 110a decides upon vibratory torque involving searching a comparatively wide range as anti-resonance torque in order to enable resonance frequency f_{c0} and anti-resonance frequency fₐ to be extracted dependably.

However, such a wide frequency band search is comparatively time-consuming.

Thus, if resonance frequency f_{c0} and anti-resonance frequency fₐ have been detected immediately before, tire condition detection apparatus 100 narrows down the search range to reduce the search time. Specifically, vibration input section 110a decides upon vibratory torque limited to a narrow frequency band that includes previous resonance frequency f_{c0} and anti-resonance frequency fₐ acquired from tire condition estimation section 130a as anti-resonance torque.

For example, vibration input section 110a sets frequency upper-limit and lower-limit values in a range that includes previous resonance frequency f_{c0} and anti-resonance frequency fₐ. Vibration input section 110a then decides upon sinusoidal torque sweeping from the lower-limit frequency to the upper-limit frequency, or from the upper-limit frequency to the lower-limit frequency, as anti-resonance torque. Alternatively, vibration input section 110a creates a band-pass filter that limits a pass band to a range that includes previous resonance frequency f_{c0} and anti-resonance frequency fₐ. Vibration input section 110a then intentionally causes white noise to be generated, and decides upon white noise torque obtained by passing this white noise through the generated band-pass filter as anti-resonance torque.

Vibration input section 110a may also perform narrowing down of the search range only if there is little variation in resonance frequency f_{c0} and anti-resonance frequency fₐ. Also, vibration input section 110a may perform narrowing down of the search range using averages of resonance frequency f_{c0} values and anti-resonance frequency fₐ values of a plurality of times. Furthermore, when performing calculation of these averages, vibration input section 110a may exclude a greatly deviating value from the average calculation. By this means, tire condition detection apparatus 100 can improve the precision of resonance frequency f_{c0} and anti-resonance frequency fₐ extraction.

When an air pressure drop has occurred in tire 200 or tire 200 has been changed, the condition of tire 200 changes greatly, and therefore it is highly probable that resonance frequency f_{c0} and anti-resonance frequency fₐ have changed significantly. Therefore, in such cases, vibration input section 110a cancels the narrowing down of the search range, and decides upon vibratory torque involving searching a comparatively wide range as anti-resonance torque.

Thus, tire condition detection apparatus 100 according to Embodiment 2 enables the resonance frequency f_{c0} and anti-resonance frequency fₐ search time to be shortened. By this means, tire condition detection apparatus 100 according to Embodiment 2 can detect the condition of tire 200 in a short time.

### Embodiment 3

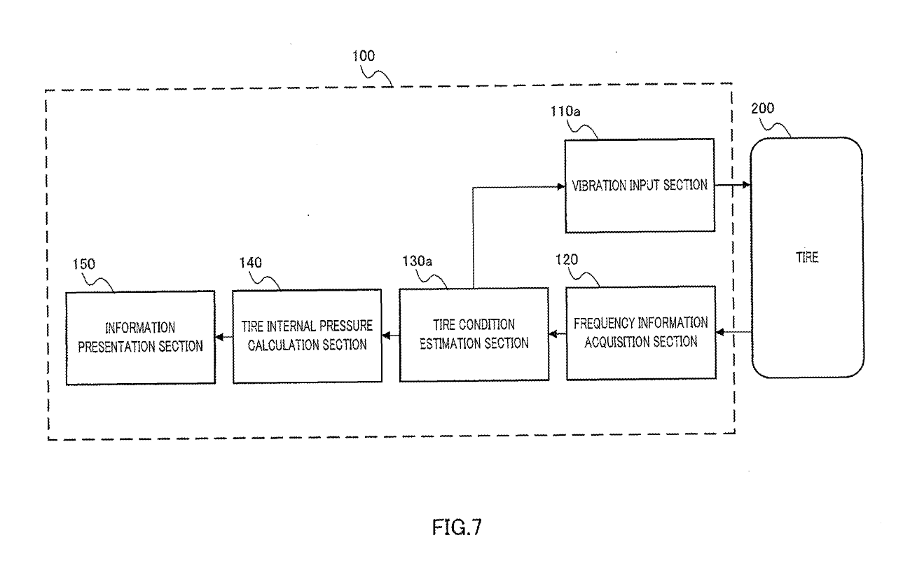

FIG. 7 is a block diagram showing an example of the configuration of a tire condition detection apparatus according to Embodiment 3 of the present invention, corresponding to FIG. 5 of Embodiment 2. Components that are identical to components in FIG. 5 are assigned the same reference symbols, and descriptions thereof are omitted in the following text.

Tire condition detection apparatus 100 according to Embodiment 3 mainly differs from Embodiment 2 in having tire internal pressure calculation section 140 and information presentation section 150.

Tire internal pressure calculation section 140 acquires torsional spring constant K(t) and outer moment of inertia J₂(t) from tire condition estimation section 130a, and calculates tire 200 internal pressure based on torsional spring constant K(t). Specifically, tire internal pressure calculation section 140, for example, stores a correlation between tire spring constant K and tire 200 internal pressure beforehand, and calculates tire 200 internal pressure from spring constant K(t) using this correlation. This correlation may be defined by means of a table, or may be defined by means of a function. Then tire internal pressure calculation section 140 outputs the calculated tire 200 internal pressure to information presentation section 150 as internal pressure information.

The correlation between torsional spring constant K and tire 200 internal pressure is a proportional relationship. Details of the proportional relationship between torsional spring constant K and tire 200 internal pressure, and a tire 200 internal pressure detection method based thereon, are given in NPL 1, for example, and therefore a description thereof is omitted here. However, the tire 200 internal pressure detection method used by tire internal pressure calculation section 140 is not limited to the method described in NPL 1.

If air pressure drop information is held in tire condition estimation section 130a, tire internal pressure calculation section 140 acquires this information and outputs it to information presentation section 150.

When internal pressure information or air pressure drop information is input from tire internal pressure calculation section 140, information presentation section 150 presents the contents of the internal pressure information or air pressure drop information to the driver. This presentation is performed, for example, by means of display on an instrument panel or car navigation apparatus display, or by means of speech output from a loudspeaker.

FIG. 8 is a flowchart showing an example of the operation of tire condition detection apparatus 100 according to Embodiment 3, corresponding to FIG. 6 of Embodiment 2. Steps that are identical to steps in FIG. 6 are assigned the same step numbers, and descriptions thereof are omitted in the following text.

When tire condition estimation section 130a determines that a tire 200 air pressure drop has occurred (S1150), tire condition estimation section 130a stores air pressure drop information, also outputs air pressure drop information to tire internal pressure calculation section 140 (S1161) and proceeds to step S1190 described later herein. Tire condition estimation section 130a determines whether or not the difference between present torsional spring constant K(t) and previous torsional spring constant K(t−1) is less than a predetermined threshold value (S1140). If the difference in question is less than the predetermined threshold value (S1140: NO), tire condition estimation section 130a outputs torsional spring constant K(t) and outer moment of inertia J₂(t) to tire internal pressure calculation section 140 (S1170). Then tire condition estimation section 130a stores torsional spring constant K(t) (S1180).

When torsional spring constant K(t) is input, tire internal pressure calculation section 140 calculates tire 200 internal pressure from torsional spring constant K (S1190). Then tire internal pressure calculation section 140 outputs the calculated internal pressure to information presentation section 150 as internal pressure information. Also, when air pressure drop information is input, tire internal pressure calculation section 140 outputs the fact that an air pressure drop has occurred in tire 200 to information presentation section 150. As a result, internal pressure information indicating tire 200 internal pressure, and air pressure drop information indicating that an air pressure drop has occurred in tire 200, are presented to the driver as appropriate according to the condition of tire 200 (S1200).

Thus, tire condition detection apparatus 100 according to Embodiment 3 presents the condition of tire 200 to the driver, enabling the driver to be prompted to take appropriate action such as inserting air or repairing a puncture. By this means, tire condition detection apparatus 100 according to Embodiment 3 enables vehicle safety and fuel consumption to be improved.

The object of information presentation is not limited to a driver, but may also be a passenger, a vehicle mechanic, or a remote observer of a vehicle. When presentation is performed for a mechanic, it is necessary for tire condition detection apparatus 100 to be provided with a recording medium that records internal pressure information and air pressure drop information, or information forming the basis of these. Also, when presentation is performed for a remote observer, it is necessary for tire condition detection apparatus 100 to be provided with a communication apparatus that transmits internal pressure information and air pressure drop information to an external apparatus such as an administrative server.

### Embodiment 4

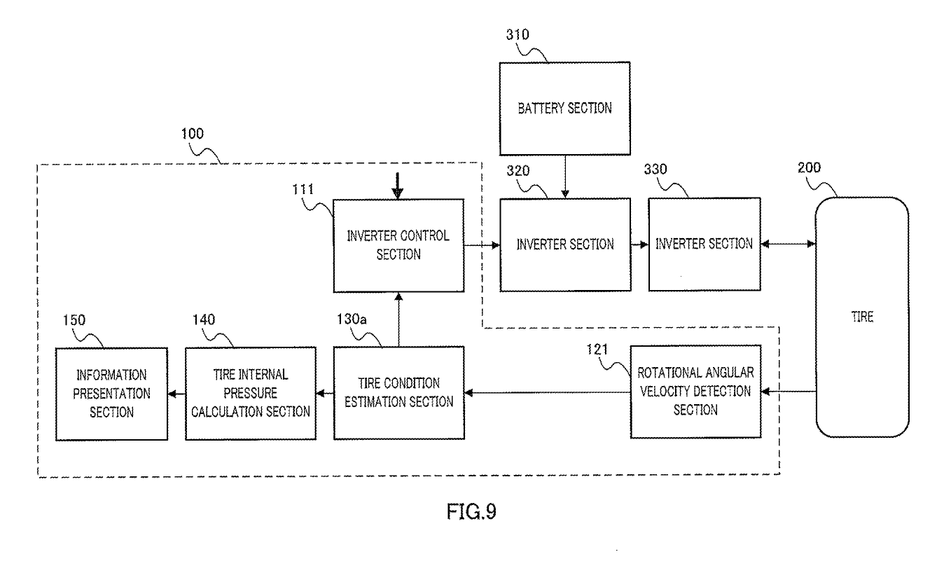

FIG. 9 is a block diagram showing an example of the configuration of a tire condition detection apparatus according to Embodiment 4 of the present invention, corresponding to FIG. 7 of Embodiment 3. Components that are identical to components in FIG. 7 are assigned the same reference symbols, and descriptions thereof are omitted in the following text.

In tire condition detection apparatus 100 according to Embodiment 4, battery section 310, inverter section 320, and motor section 330 are applied to tire 200 as a drive system. Tire condition detection apparatus 100 according to Embodiment 4 mainly differs from Embodiment 3 in that vibration input section 110a is replaced by inverter control section 111, and frequency information acquisition section 120 is replaced by rotational angular velocity detection section 121.

Battery section 310 is a storage battery that supplies inverter section 320 with power necessary for inverter section 320 to output a current.

Inverter section 320 outputs power to motor section 330 in accordance with a motor drive current output command value input from inverter control section 111 described later herein.

Motor section 330 generates torque by means of power supplied from inverter section 320, and drives tire 200.

Inverter control section 111 inputs operation information indicating a degree of depression of an accelerator pedal (not shown) depressed by the driver in order to cause the vehicle to accelerate (hereinafter referred to simply as “operation information”). Then inverter control section 111 decides a value of torque applied to tire 200 for vehicle running (hereinafter referred to as “running torque”) based on the operation information. Also, inverter control section 111 decides anti-resonance torque in the same way as vibration input section 110a of Embodiment 3. Then inverter control section 111 outputs to inverter section 320 a motor drive current output command value such that combined torque comprising resonance torque and running torque (hereinafter referred to simply as “combined torque”) is output from motor section 330.

Furthermore, inverter control section 111 detects an actual output value of a motor section 330 motor drive current by means of a current detection section (not shown). Then inverter control section 111 controls the inverter section 320 power supply to motor section 330 so that this actual output value matches an output command value calculated by inverter control section 111.

Inverter control section 111 may perform generation of such an output command value by calculating a combined torque value, or by combining (adding together) an anti-resonance current and running current. Here, “anti-resonance current” is a motor drive current for generating anti-resonance torque. Also, “running current” is a motor drive current for generating running torque. Further, hereinafter, where appropriate, a motor drive current for generating combined torque is referred to as “combined drive current”.

Rotational angular velocity detection section 121 detects rim rotational angular velocity ω₁ of tire 200 from tire 200, and outputs this to tire condition estimation section 130a as above-described frequency information. For example, rotational angular velocity detection section 121 acquires a rim rotation angle from an encoder (not shown) that is constituted by a rotor that rotates in synchrony with tire 200, and a sensor that detects a rotation angle of the rotor and converts the rotation angle into an electrical signal. Then rotational angular velocity detection section 121 calculates rotational angular velocity ω₁ by performing temporal differentiation on rim rotation angles.

Rotational angular velocity detection section 121 may acquire a rotation angle using, for example, an optical encoder such as an incremental encoder or absolute encoder, or an electromagnetic encoder comprising a Hall element or the like.

Tire condition estimation section 130a calculates tire 200 resonance frequency f_{c0} and anti-resonance frequency fₐ based on rotational angular velocity ω₁ input from rotational angular velocity detection section 121.

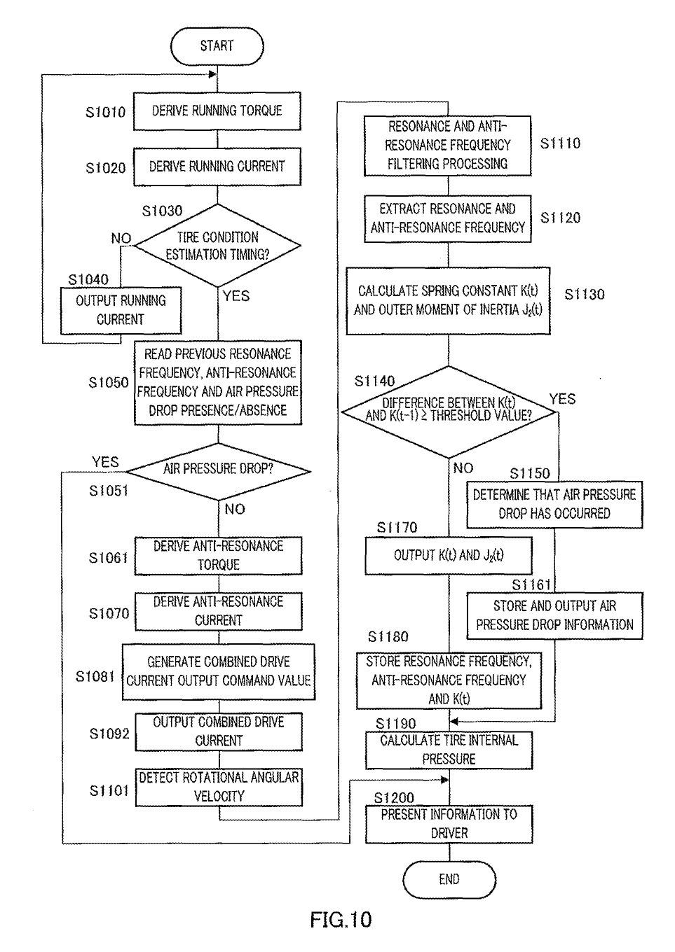

FIG. 10 is a flowchart showing an example of the operation of tire condition detection apparatus 100 according to Embodiment 4, corresponding to FIG. 8 of Embodiment 3. Steps that are identical to steps in FIG. 8 are assigned the same step numbers, and descriptions thereof are omitted in the following text.

First, when the accelerator pedal is depressed, inverter control section 111 derives a running torque value based on the degree of depression of the accelerator pedal (S1010), and derives a running current corresponding to the running torque value (S1020). Then, if this is not estimation execution timing (S1030: NO), inverter control section 111 outputs the running current to inverter section 320 as an output specifying value. As a result, only the running current is output from motor section 330 as a motor drive current (S1040), and only running torque is applied to tire 200.

On the other hand, if this is estimation execution timing (S1030: YES), inverter control section 111 reads previous resonance frequency f_{c0} and anti-resonance frequency fₐ (S1050). If there is no air pressure drop (S1051: NO), inverter control section 111 derives anti-resonance torque for causing vibration including previous resonance frequency f_{c0} and anti-resonance frequency fₐ to be generated (S1061). Then inverter control section 111 derives an anti-resonance current corresponding to the anti-resonance torque value (S1070), generates an output command value of a combined drive current in which a running current and anti-resonance current are superposed, and outputs this combined drive current output command value to inverter section 320 (S1081). As a result, a combined drive current is output from motor section 330 as a motor drive current (S1091), and combined drive torque is applied to tire 200.

Then rotational angular velocity detection section 121 detects tire 200 rotational angular velocity ω₁, and outputs this to tire condition estimation section 130a as a time series rotational angular velocity signal (S1101). Tire condition estimation section 130a passes the input rotational angular velocity signal through an above-described band-pass filter that takes a band including previous resonance frequency f_{c0} and anti-resonance frequency fₐ as a pass band (S1110). Then tire 200 resonance frequency f_{c0} and anti-resonance frequency fₐ are extracted from the rotational angular velocity signal that has passed through the band-pass filter (S1120).

Thus, tire condition detection apparatus 100 according to Embodiment 4 has operation information as input, and performs input of running torque and anti-resonance torque by controlling the motor drive current value. By this means, tire condition detection apparatus 100 according to Embodiment 4 can easily input anti-resonance vibration to tire 200 of a drive system capable of acquiring operation information and capable of specifying a motor drive current value.

Also, tire condition detection apparatus 100 according to Embodiment 4 inputs anti-resonance vibration from motor section 330 connected to tire 200 in a stable and fixed manner. By this means, tire condition detection apparatus 100 according to Embodiment 4 can reduce the effects of a vibration component other than a resonance frequency and an anti-resonance frequency in frequency information.

Furthermore, tire condition detection apparatus 100 according to Embodiment 4 acquires rotational angular velocity acquired from a rotational angular velocity sensor installed in order to drive motor section 330 as frequency information. Consequently, in tire condition detection apparatus 100 according to Embodiment 4, the provision of a separate sensor for detecting vibration is unnecessary.

When a vehicle is stopped, the driver is not depressing the accelerator pedal, and running torque is zero. Therefore, if tire condition detection apparatus 100 performs detection of the condition of tire 200 while the vehicle is stopped, only anti-resonance torque is input to tire 200.

### Embodiment 5

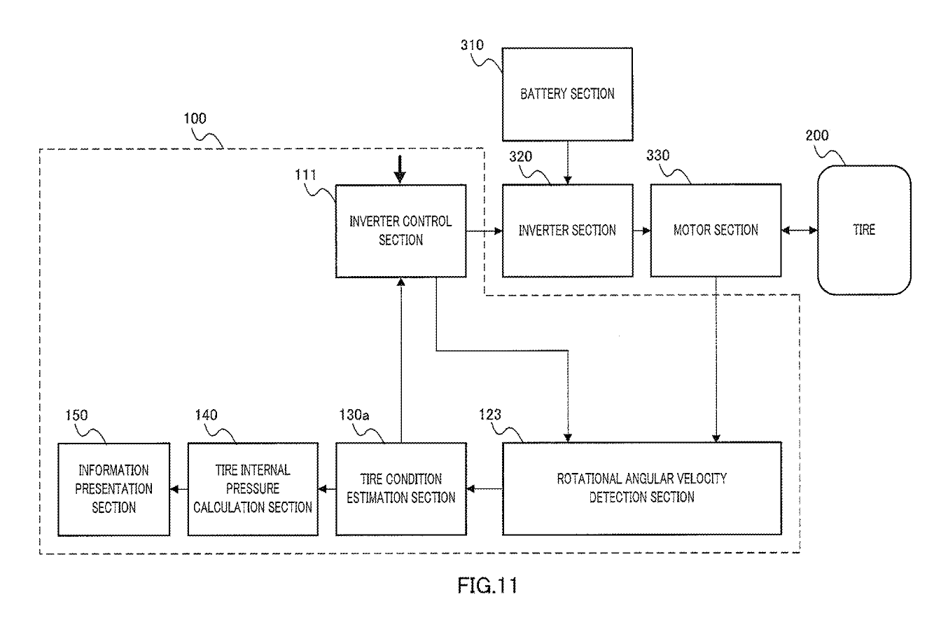

FIG. 11 is a block diagram showing an example of the configuration of a tire condition detection apparatus according to Embodiment 5, corresponding to FIG. 9 of Embodiment 4. Components that are identical to components in FIG. 9 are assigned the same reference symbols, and descriptions thereof are omitted in the following text.

Tire condition detection apparatus 100 according to Embodiment 5 mainly differs from Embodiment 4 in that rotational angular velocity detection section 121 is replaced by rotational angular velocity detection section 123 that detects a rotational angular velocity of tire 200 using an actual output value of a motor drive current.

Rotational angular velocity detection section 123 calculates tire 200 rim rotational angular velocity ω₁ from motor drive current actual output value I_{q}, and outputs this rotational angular velocity ω₁ to tire condition estimation section 130a. Here, motor drive current actual output value I_{q} is a current value acquired from a current acquisition section (not shown) installed between inverter section 320 and motor section 330.

The method of calculating rotational angular velocity ω₁ from motor drive current actual output value I_{q} in rotational angular velocity detection section 123 will now be described.

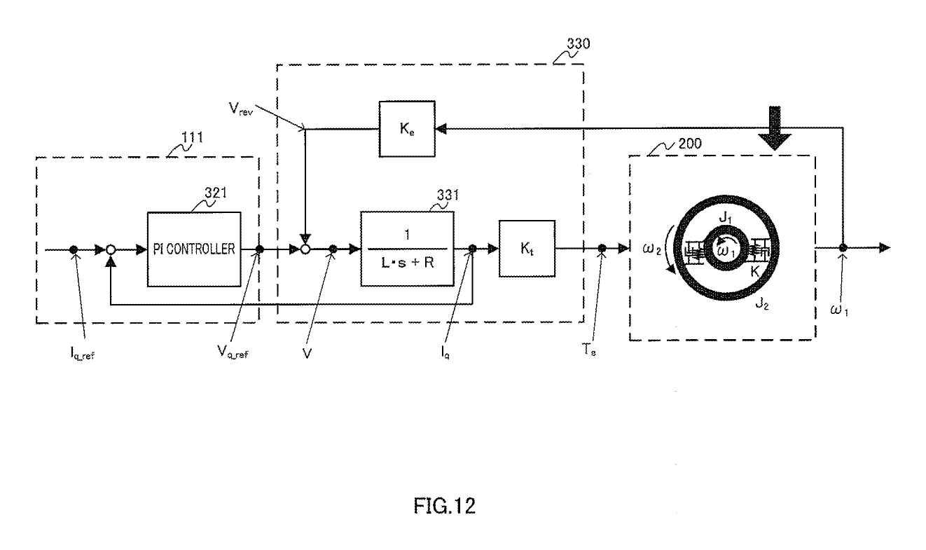

FIG. 12 is a control block diagram showing an example of the configuration of a motor drive system.

PI controller 321 of inverter control section 111 is a controller that controls actual output value I_{q} of a current flowing through motor section 330 so that a combined drive current actual output value flowing through motor section 330 matches a combined drive current (command value) calculated by inverter control section 111. That is to say, PI controller 321 applies control voltage V_{q}_{_{—}}_{ref} such that motor section 330 actual output value I_{q} matches output command value I_{q}_{_{—}}_{ref} calculated by inverter control section 111 to motor section 330.

Motor circuit 331 is an electronic circuit that can be modeled by means of wound coil inductance L and wound coil resistance R. By means of actual output value I_{q}, output torque Tₑ proportional to torque constant Kₜ is applied to tire 200. Then the rotor of motor section 330 rotates at rotational angular velocity ω₁ together with the rotation of tire 200. At this time, counter electromotive force—Kₑω₁ (Kₑ is a proportional constant) proportional to rotor rotational angular velocity ω₁ is generated in motor section 330, and voltage V=V_{q}_{_{—}}_{ref}−Kₑω₁ is input to both ends of the wound coil of motor section 330 as an actual input voltage value. Equation 14 below is derived from this relationship.

$$\begin{matrix}[ 14 ] & \\ {\hat{ω}}_{1} = \frac{1}{{K}_{e}} ( {V}_{q \_ ref} - V ) = \frac{1}{{K}_{e}} ( {V}_{q \_ ref} - L {\dot{I}}_{q} - {RI}_{q} ) & ( Equation 14 )\end{matrix}$$

Rotational angular velocity detection section 123 calculates motor section 330 rotational angular velocity (that is, tire 200 rim rotational angular velocity) ω₁ from actual output value I_{q} and control voltage V_{q}_{_{—}}_{ref} using equation 14, and outputs this rotational angular velocity ω₁ to tire condition estimation section 130a.

Thus, tire condition detection apparatus 100 according to Embodiment 5 can detect rotational angular velocity ω₁ from an actual output value of a drive current output to motor section 330 and a control voltage calculated by inverter control section 111. By this means, tire condition detection apparatus 100 according to Embodiment 5 enables an encoder or suchlike sensor to be made unnecessary.

In Embodiment 5, motor section 330 is a synchronous motor with a surface magnet structure in which a permanent magnet is attached to the surface of the rotor, and current control in which the d-axis current is zero is assumed, but the configuration of motor section 330 is not limited to this. For example, it is possible to detect rotational angular velocity ω₁ in a similar way in a case in which motor section 330 is a synchronous motor with an embedded magnet structure in which a permanent magnet is embedded within the rotor, and a current control system in which the d-axis current is non-zero is assumed.

### Embodiment 6

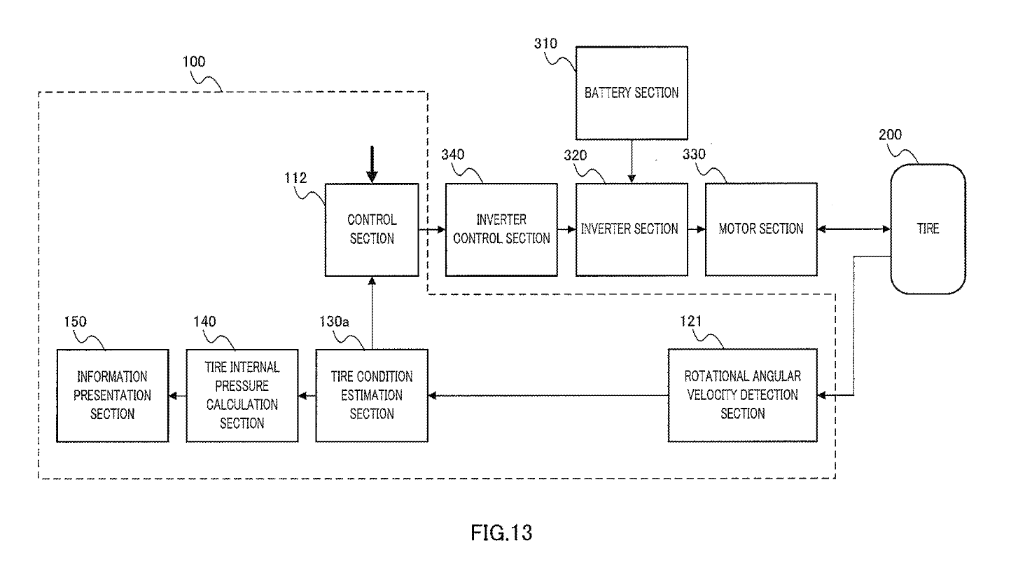

FIG. 13 is a block diagram showing an example of the configuration of a tire condition detection apparatus according to Embodiment 6, corresponding to FIG. 9 of Embodiment 4. Components that are identical to components in FIG. 9 are assigned the same reference symbols, and descriptions thereof are omitted in the following text.

In tire condition detection apparatus 100 according to Embodiment 6, battery section 310, inverter section 320, motor section 330, and inverter control section 340 are applied to tire 200 as a drive system. Tire condition detection apparatus 100 according to Embodiment 6 mainly differs from Embodiment 4 in that inverter control section 111 is replaced by control section 112.

Based on a tire 200 output torque value input from control section 112 described later herein, inverter control section 340 calculates a motor drive current output command value such that that output torque is output by motor section 330. Alternatively, based on a motor drive current such that tire 200 output torque is output by motor section 330, input from control section 112 described later herein, inverter control section 340 calculates an output command value to output that motor drive current. Then inverter control section 340 outputs the calculated output command value to inverter section 320.

In the same way as vibration input section 110a described in Embodiment 3, control section 112 decides a running torque value and an anti-resonance torque value based on operation information. Then control section 112 outputs a value of combined torque combining anti-resonance torque and running torque to inverter control section 340 as a tire 200 output torque value. Output of an output torque value may be performed by means of motor drive current output to motor section 330 for outputting output torque to tire 200, rather than an output torque value itself.

Thus, tire condition detection apparatus 100 according to Embodiment 6 inputs operation information, and performs input of running torque and anti-resonance torque by controlling the output torque value. By this means, tire condition detection apparatus 100 according to Embodiment 6 can easily input anti-resonance vibration to tire 200 of a drive system capable of acquiring operation information and capable of specifying an output torque value.

### Embodiment 7

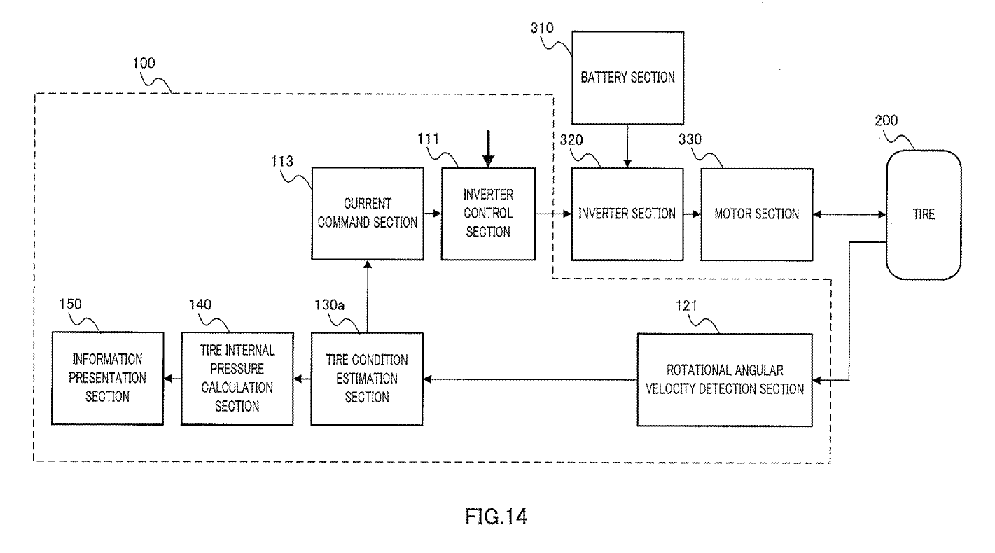

FIG. 14 is a block diagram showing an example of the configuration of a tire condition detection apparatus according to Embodiment 7 of the present invention, corresponding to FIG. 9 of Embodiment 4. Components that are identical to components in FIG. 9 are assigned the same reference symbols, and descriptions thereof are omitted in the following text.

Tire condition detection apparatus 100 according to Embodiment 7 mainly differs from Embodiment 4 in having current command section 113.

Current command section 113 decides anti-resonance torque in the same way as inverter control section 111 of Embodiment 4. Then current command section 113 outputs a motor drive current value such that the decided anti-resonance torque is output by motor section 330, to inverter control section 111 as an anti-resonance current value.

Inverter control section 111 decides a running torque value corresponding to a degree of depression of the accelerator pedal, and calculates a running current value such that this running torque is output by motor section 330. Then inverter control section 111 calculates a combined drive current value by adding the anti-resonance current value input from current command section 113 to the running current value, and outputs the result of this calculation to inverter section 320 as an output command value.

Thus, tire condition detection apparatus 100 according to Embodiment 7 has current command section 113 that generates an anti-resonance current that causes natural vibration to be generated in tire 200. Tire condition detection apparatus 100 according to Embodiment 7 outputs a combined drive current superposed on a running current to motor section 330, and performs input of running torque and anti-resonance torque. By this means, tire condition detection apparatus 100 according to Embodiment 7 can easily input anti-resonance vibration to tire 200.

### Embodiment 8

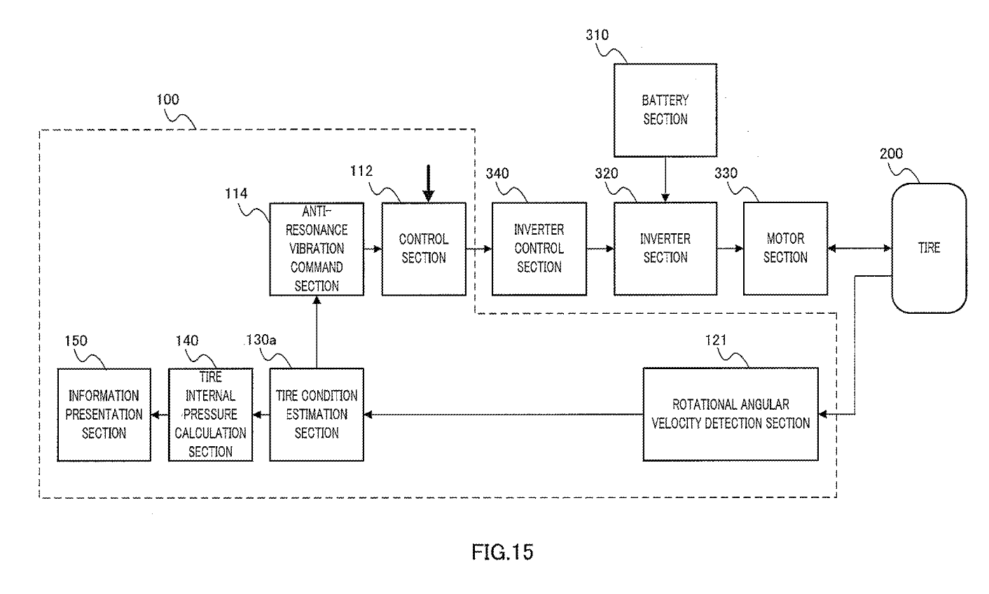

FIG. 15 is a block diagram showing an example of the configuration of a tire condition detection apparatus according to Embodiment 8, corresponding to FIG. 13 of Embodiment 6. Components that are identical to components in FIG. 13 are assigned the same reference symbols, and descriptions thereof are omitted in the following text.

Tire condition detection apparatus 100 according to Embodiment 8 mainly differs from Embodiment 6 in having anti-resonance vibration command section 114.

Anti-resonance vibration command section 114 decides anti-resonance torque in the same way as current command section 113 of Embodiment 7. Then anti-resonance vibration command section 114 outputs the decided anti-resonance torque value to control section 112.

Control section 112 decides running torque corresponding to a degree of depression of an accelerator pedal (not shown) depressed by the driver in order to cause the vehicle to accelerate. Then control section 112 calculates combined torque comprising anti-resonance torque input from anti-resonance vibration command section 114 and running torque, and outputs this combined torque to inverter control section 340.

Alternatively, control section 112 derives a motor drive current (that is, running current) value such that this running torque is output from motor section 330. Furthermore, control section 112 derives a motor drive current (that is, anti-resonance current) such that anti-resonance torque input from anti-resonance vibration command section 114 is output by motor section 330. Then control section 112 generates a combined drive current in which the anti-resonance current is superposed on the running current, and outputs this combined drive current to inverter control section 340.

Thus, tire condition detection apparatus 100 according to Embodiment 8 has anti-resonance vibration command section 114 that generates anti-resonance torque that causes natural vibration to be generated in tire 200. Tire condition detection apparatus 100 according to Embodiment 8 outputs a combined drive current based on combined torque superposed with running torque to motor section 330, and performs input of running torque and anti-resonance torque. By this means, tire condition detection apparatus 100 according to Embodiment 8 can easily input anti-resonance vibration to tire 200 of a drive system capable of specifying a motor drive current value for tire 200.

### Embodiment 9

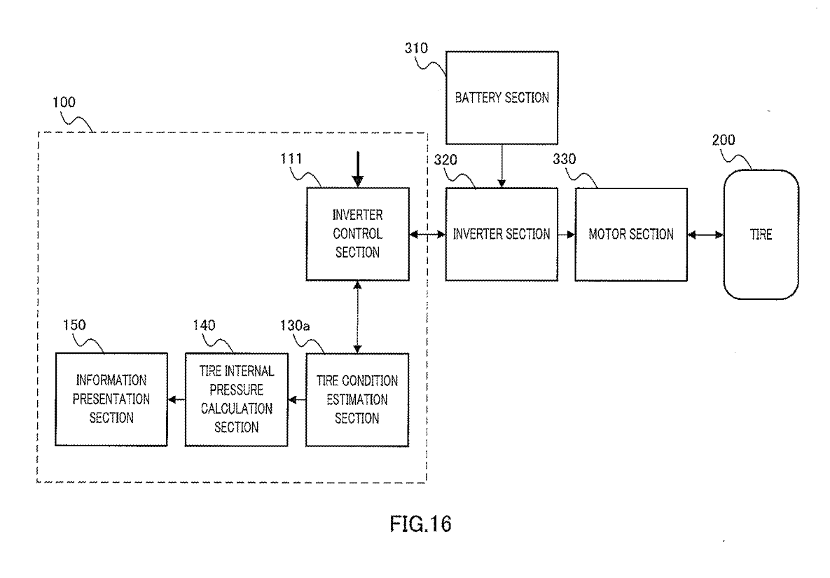

FIG. 16 is a block diagram showing an example of the configuration of a tire condition detection apparatus according to Embodiment 9, corresponding to FIG. 9 of Embodiment 4. Components that are identical to components in FIG. 9 are assigned the same reference symbols, and descriptions thereof are omitted in the following text.

Tire condition detection apparatus 100 according to Embodiment 9 mainly differs from Embodiment 4 in that rotational angular velocity detection section 121 is not provided.

Tire condition estimation section 130a inputs control voltage V_{q}_{_{—}}_{ref} for motor section 330 in FIG. 12 calculated by inverter control section 111. Then tire condition estimation section 130a calculates resonance frequency f_{c0} and anti-resonance frequency fₐ, by means of the method below, for example, and estimates the condition of tire 200.

Equation 15 below is derived from the relationship illustrated in FIG. 12.

V_{q}_{_{—}}_{ref}=Kₑ\hat{ω}₁+V=Kₑ\hat{ω}₁+(Lİ_{q}+RI_{q}) (Equation 15)

In this equation 15, the right-hand second term+third term (I_{q} terms) are controlled so that motor section 330 outputs motor drive current output command value I_{q}_{_{—}}_{ref} input from inverter control section 111. Consequently, the same frequency characteristic as for output command value I_{q}_{_{—}}_{ref} that is the input appears in the right-hand second term+third term (I_{q} terms). On the other hand, the right-hand first term (Kₑω₁ term) is a counter-electromotive force generated according to vibration that includes resonance frequency f_{c0} and anti-resonance frequency fₐ as illustrated in equations 1 to 4. Therefore, by using control voltage V_{q}_{_{—}}_{ref} of equation 15, it is possible to detect torsional spring resonance frequency f_{c0} and anti-resonance frequency fₐ that are affected by tire internal pressure.

Resonance frequency f_{c0} and anti-resonance frequency fₐ can be detected from control voltage V_{q}_{_{—}}_{ref} by performing above-mentioned frequency analysis on control voltage V_{q}_{_{—}}_{ref} and detecting a sharp peak position indicating resonance frequency f_{c0} and anti-resonance frequency fₐ. Also, resonance frequency f_{c0} and anti-resonance frequency fₐ can be detected from control voltage V_{q}_{_{—}}_{ref} utilizing the above-mentioned recursive least-squares estimation method.

When utilizing the recursive least-squares estimation method, equation 16 below is derived by introducing equation 15 into the aforementioned equation 6. Here, observable vector ξ and observable output y are defined as shown below in equation 17 and equation 18, respectively.

$$\begin{matrix}[ 16 ] & \\ [ \begin{matrix}{θ}_{1} & {θ}_{2}\end{matrix} ] [ \begin{matrix}\frac{{J}_{1}}{{K}_{e}} ( {\dot{V}}_{q \_ ref} - \dot{V} ) \\ - {T}_{e}\end{matrix} ] = {\ddot{T}}_{e} - \frac{{J}_{1}}{{K}_{e}} ( {{V}^{...}}_{q \_ ref} - {V}^{...} ) & ( Equation 16 ) \\ [ 17 ] & \\ ξ = {[ \frac{{J}_{1}}{{K}_{e}} ( {\dot{V}}_{q \_ ref} - \dot{V} ) - {T}_{e} ]}^{T} & ( Equation 17 ) \\ [ 18 ] & \\ y = {\ddot{T}}_{e} - \frac{{J}_{1}}{{K}_{e}} ( {{V}^{...}}_{q \_ ref} - {V}^{...} ) & ( Equation 18 ]\end{matrix}$$

Tire condition estimation section 130a determines resonance frequency f_{c0} and anti-resonance frequency fₐ from unknown parameter θ by the recursive least-squares estimation method described in Embodiment 1. Unknown parameter vector θ=[θ₁ θ₂]^{T}=[ω_{c0}² ωₐ²]^{T}=[4π²f_{c0}² 4π²fₐ²]^{T} is as explained above.

Thus, tire condition detection apparatus 100 according to Embodiment 9 estimates the condition of tire 200 from a control voltage for motor section 330, enabling a rotational angular velocity detection section to be made unnecessary. That is to say, without using a sensor that detects the angle or rotational angular velocity of tire 200, tire condition detection apparatus 100 according to Embodiment 9 can detect the condition of tire 200 with a precision equivalent to that of a configuration that uses such a sensor.

Tire condition detection apparatuses according to Embodiment 4 through Embodiment 9 have been assumed to control an input signal to an inverter section as a method of inputting predetermined vibration to a tire, but an input signal (that is, a control voltage) to a motor section may also be controlled directly. That is to say, a tire condition detection apparatus may have a configuration that includes an inverter section.

Tire condition detection apparatuses according to Embodiment 4 through Embodiment 9 need not necessarily be provided with a tire internal pressure calculation section and an information presentation section.

Tire condition detection apparatuses according to Embodiment 6 through Embodiment 8 may be provided with rotational angular velocity detection section of Embodiment 5 that calculates from motor drive current instead of a rotational angular velocity detection section.

Tire condition detection apparatuses according to Embodiment 6 through Embodiment 8 need not necessarily be provided with a rotational angular velocity detection section, and may extract a resonance frequency and an anti-resonance frequency from a control voltage as described in Embodiment 9.

The disclosure of Japanese Patent Application No. 2010-229917, filed on Oct. 12, 2010, including the specification, drawings and abstract, is incorporated herein by reference in its entirety.

### INDUSTRIAL APPLICABILITY

A tire condition detection apparatus and a tire condition detection method according to the present invention are suitable for use as a tire condition detection apparatus and tire condition detection method enabling tire condition to be detected with a high degree of precision.

### REFERENCE SIGNS LIST

100 Tire condition detection apparatus
110, 110a Vibration input section
111, 340 Inverter control section
112 Control section
113 Current command section
114 Anti-resonance vibration command section
120 Frequency information acquisition section
121 Rotational angular velocity detection section
123 Rotational angular velocity detection section
130, 130a Tire condition estimation section
140 Tire internal pressure calculation section
150 Information presentation section
200 Tire
310 Battery section
320 Inverter section
321 PI controller
330 Motor section
331 Motor circuit

1. A tire condition detection apparatus that detects a tire condition of a pneumatic tire fixed to a wheel, the tire condition detection apparatus comprising:
a vibration input section that inputs predetermined vibration to the tire;
a frequency information acquisition section that acquires frequency information of the tire when the predetermined vibration is input; and
a tire condition estimation section that extracts a resonance frequency and an anti-resonance frequency of the tire from the acquired frequency information, and calculates an outer moment of inertia and a spring constant when the tire is modeled using the outer moment of inertia, an inner moment of inertia, and the spring constant of elastic force acting therebetween, from the extracted tire resonance frequency and anti-resonance frequency.

2. The tire condition detection apparatus according to claim 1, wherein the tire condition estimation section detects an occurrence of an air pressure drop of the tire from a change in the spring constant.

3. The tire condition detection apparatus according to claim 1, wherein the frequency information acquisition section acquires rotational angular velocity of the tire as the frequency information.

4. The tire condition detection apparatus according to claim 2, wherein the vibration input section, when the occurrence of an air pressure drop is detected and when a previously extracted resonance frequency and anti-resonance frequency of the tire do not exist, decides upon a first frequency band as a frequency of the predetermined vibration, and when the occurrence of an air pressure drop has not been detected and the previously extracted resonance frequency and anti-resonance frequency of the tire exist, decides upon a second frequency band that includes the previously extracted resonance frequency and anti-resonance frequency of the tire and is narrower than the first frequency band as a frequency of the predetermined vibration.

5. The tire condition detection apparatus according to claim 2, further comprising:
a tire internal pressure calculation section that calculates internal pressure of the tire from the calculated spring constant; and
an information presentation section that presents at least one of the calculated internal pressure and the detected occurrence of an air pressure drop.

6. The tire condition detection apparatus according to claim 1, wherein:
the wheel is a wheel driven by a motor; and
the vibration input section controls a control voltage for the motor of an inverter that supplies a current to the motor so that the predetermined vibration is generated from the motor.

7. The tire condition detection apparatus according to claim 6, wherein the vibration input section controls the control voltage so that a combined drive current in which a resonance current and an anti-resonance current for the predetermined vibration are superposed on a running current for rotation of the tire is output from the motor.

8. The tire condition detection apparatus according to claim 3, wherein the frequency information acquisition section acquires the rotational angular velocity from a drive current output from the motor.

9. The tire condition detection apparatus according to claim 7, wherein the vibration input section calculates command information for performing control so that an inverter that supplies current to the motor generates the predetermined vibration from the motor.

10. The tire condition detection apparatus according to claim 1, wherein:
the wheel is a wheel driven by a motor;
the vibration input section controls a control voltage for the motor of an inverter that supplies a current to the motor so that the predetermined vibration is generated from the motor; and
the frequency information acquisition section acquires the control voltage as the frequency information.

11. A tire condition detection method for detecting a tire condition of a pneumatic tire fixed to a wheel, the tire condition detection method comprising:
inputting predetermined vibration to the tire;
acquiring frequency information of the tire when the predetermined vibration is input;
extracting a resonance frequency and an anti-resonance frequency of the tire from the acquired frequency information; and
calculating an outer moment of inertia and a spring constant when the tire is modeled using the outer moment of inertia, an inner moment of inertia, and the spring constant of elastic force acting therebetween, from the extracted tire resonance frequency and anti-resonance frequency.
